(19) United States
(12) Patent Application Publication
(10) Pub. No.: US 2024/0262103 A1
(43) Pub. Date: Aug. 8, 2024

(54) METHODS, APPARATUS AND CONTROLLER FOR A DROPLET EJECTION APPARATUS

(71) Applicant: Xaar Technology Limited, Huntingdon (GB)

(72) Inventors: Mario MASSUCCI, Huntingdon (GB); Andrew COX, Huntingdon (GB)

(21) Appl. No.: 18/566,368

(22) PCT Filed: Jun. 3, 2021
(86) PCT No.: PCT/GB2021/051381

§ 371 Date: Dec. 1, 2023

(51) Int. Cl. B41J 2/045

(52) U.S. Cl. CPC B41J 2/0459; B41J 2/04573; B41J 2/04596

(57) ABSTRACT

A method for providing a drive waveform for a droplet ejection apparatus. The method includes the steps of receiving a nominal drive waveform including a droplet ejection pulse having a nominal maximum amplitude Vmax(nominal) and for achieving a nominal droplet velocity vel(nominal) and further including a nominal non-ejecting pulse, ahead of the droplet ejection pulse, wherein the nominal non-ejecting pulse is spaced apart from the droplet ejection pulse by a first delay d1; receiving a target droplet velocity vel(target) and/or a target maximum amplitude of the droplet ejection pulse Vmax(target); adjusting one or more waveform parameters on the basis of the received vel(target) and/or Vmax(target) to provide an adjusted drive waveform to achieve at least one of vel(target) and Vmax(target); and outputting the adjusted drive waveform. A method is also provided for operating a droplet ejection apparatus.

### FIELD OF THE INVENTION

The present invention relates to the field of droplet ejection, and in particular to methods of operation for a droplet ejection apparatus, a controller therefor and a droplet ejection apparatus carrying out the method. More particularly, the droplet ejection apparatus and methods of operation therefor provide improved drive waveforms for operating the droplet ejection apparatus with improved efficiency.

### BACKGROUND

A droplet ejection apparatus comprises a droplet ejection head which comprises an array of fluid chambers, each bounded in part by a piezoelectric actuating element, and in fluidic communication with a nozzle for ejection of droplets therefrom upon deformation of the actuating element. The design of the droplet ejection head may take various forms, for example the actuating element may be in the form of opposing piezoelectric side walls bounding each chamber, the chambers formed by grooves in a sheet of piezoelectric material, or it may for example form the roof of a chamber in so-called roof mode actuator heads.

A variety of alternative fluids may be ejected by a droplet ejection head. For instance, a droplet ejection head may eject droplets of fluid that may travel towards a receiving medium, such as paper or card, ceramic tiles or shaped articles (e.g. cans, bottles etc.), to form an image, as is the case in inkjet printing applications (where the droplet ejection head may be an inkjet printhead or, more particularly, a drop-on-demand inkjet printhead).

Droplets of fluid may be used to build structures, for example electrically active fluids may be deposited onto receiving media such as a circuit board so as to enable prototyping of electrical devices or to deposit droplets of solution containing biological or chemical material onto a receiving medium such as a microarray. Droplet ejection heads may be used in applications without a receiving medium. For example, a fine vapour or mist may be generated by droplet ejection heads to control humidity in greenhouse misting systems. Droplet ejection heads suitable for such alternative fluids may be generally similar in construction to printheads, with some adaptations made to handle the specific fluid in question. In such droplet ejection heads, the pattern of droplets ejected varies in dependence upon the control data provided to the head.

One configuration of piezoelectric actuator elements uses actuator elements formed from a continuous sheet of piezoelectric material into which parallel grooves are sawn to form longitudinal fluid chambers. An array of fluid chambers of one such known configuration, providing a “side shooter” droplet ejection head, is shown in schematic cross section in FIG. 1. A plurality of fluid chambers 110 (e.g. 110_1, 110_2, . . . ) are arranged side-by-side in an array which extends from left to right, along direction x. Each of the fluid chambers 110 is provided with a nozzle 172, from which fluid contained within the fluid chamber 110 may be ejected, in a manner that will be described below. Each of the fluid chambers 110 is elongate in a chamber length direction (into the page, along y) perpendicular to the array direction x. Adjacent fluid chambers 110 within the array are separated by chamber walls 130, which may be formed of a piezoelectric material such as lead zirconate titanate (PZT), or similar materials, which are deformable upon application of a potential difference across them. One longitudinal side of each of the fluid chambers 110 is bounded (at least in part) by a nozzle plate 170, which provides a nozzle 172 for each of the chambers 110.

The other, opposing, longitudinal side of each of the fluid chambers 110 is bounded (at least in part) by a substrate 180, which may be substantially planar. In some arrangements, the substrate 180 may be integral with a part of, or all of, each of the walls 130. Each fluid chamber is internally coated with an electrode, so that each wall 130 is provided with a first electrode, e.g. 101_1, by the fluid chamber to one side, e.g. fluid chamber 110_1, and a second electrode, e.g. 101_2, is provided by the adjacent fluid chamber, e.g. fluid chamber 110_2. The two electrodes for the wall 130 are configured so as to be able to apply a drive waveform to the wall 130. The electrodes may be formed prior to attaching the nozzle plate 170 to the walls 130, by deposition of a continuous layer of conductive material inside the fluid chambers, for example by electroplating, over the surface of the substrate 180 and also over the surfaces of the fluid chambers.

Each wall 130 may comprise a first portion 131 and a second portion 132, with the respective piezoelectric material of the portions being poled in opposite directions to each other (as indicated by the arrows). The poling direction of each of the first portion 131 and the second portion 132 is perpendicular to the array direction and to the chamber length direction. The first 131 and second 132 portions may be formed of two bonded sheets of opposite poled material which are joined together before the grooves forming the fluid chambers are cut. Such first and second portions provide a ‘chevron’ deformation of the walls when a potential difference is applied across the wall 130 by applying drive waveforms to the first and second electrodes, whereby the first and second portions 131, 132 deform in shear mode in opposite senses, as is shown in dashed-line in FIG. 1.

In FIG. 1, the drive waveforms applied to the walls bounding the fluid chamber 110_2 cause them to deform outwardly from the fluid chamber, which has the effect of drawing fluid into the fluid chamber 110_2. Upon reversal of the direction of the electric field applied across the walls 130 bounding the fluid chamber 110_2, the walls deform inwardly. Where the magnitude of the pressure caused by the inward deformation exceeds a certain level, a droplet of fluid may be ejected from the nozzle 172 of the fluid chamber 110_2.

The wall 130 may be addressed by a series of potential differences such that it deforms alternately inwardly or outwardly from one of the two fluid chambers 110 it bounds, or it may remain undeformed. Drive schemes for these types of droplet ejection heads are well known, such as the 3-cycle drive scheme when the droplet ejection head is used as a printhead. This drive scheme causes three groups of nozzles A, B, C to successively deposit droplets into the same pixel line on the media. Due to the single, continuous electrode provided in each fluid chamber 110, this 3-cycle scheme may be necessary in some applications to ensure reliable ejection from a fluid chamber 110 while preventing ejection from the two adjacent fluid chambers.

As described above, droplet ejection is caused by the application of the drive waveform formed from drive signals applied to respective ones of each electrode of the walls of the selected fluid chamber 110. The drive waveform used to drive the droplet ejection head may take any form depending on the structure of the droplet ejection head. For example, the drive waveform may be of trapezoidal shape, rectangular, square, triangular or a sinusoidal wave. Further, the maximum and minimum voltage of the drive waveform used to drive the droplet ejection head may depend on the structure of the head and/or on the voltage capacity or configuration of drive circuitry.

In one example, with the electrodes of neighbouring fluid chambers quiescent, the drive waveform causes the two walls of a chamber to move in unison first out of and then into the selected fluid chamber 110 so as to eject a droplet through the so-called draw and release mechanism. This movement into and out of the fluid chamber may be repeated in a multi-pulse mode for e.g. binary or greyscale mode of operation to eject a droplet which is formed from a varying number of sub-droplets, the number of sub-droplets being determined by the number of repetitions of the drive waveform.

The drive waveform is typically designed to take into consideration the acoustic behaviour of the ink filled fluid chamber; a particularly important parameter being L/c where L is the acoustic length of the fluid chamber and c is the speed of sound in the fluid chamber. It is therefore known to be advantageous to apply a negative pulse, followed by a positive pulse, where ‘negative’ and ‘positive’ may denote the direction of the electric field applied across the chamber wall, rather than a voltage level of the droplet ejection pulse with respect to ground. A similar consideration is taken into account for other designs of droplet ejection head.

When the drive waveform switches from negative to positive, it causes both of the opposing chamber walls to deform from out of the chamber to into the chamber, the chamber pressure is increased and a droplet is ejected. If the durations of the positive pulse and the negative pulse and their respective amplitudes and positions are not carefully selected, the pressure fluctuations in the chamber after droplet ejection and the peak amplitude of the pressure fluctuation after droplet ejection may be high enough to affect neighbouring chambers through the fluidic connection of a common supply manifold, such that the positive pulse leads to accidental droplet ejection from neighbouring chamber(s).

FIG. 2 shows a conventional basic drive waveform 40 that comprises a first, negative droplet ejection pulse 44 followed by a second, positive droplet ejection pulse 46 of equal amplitude about a reference voltage of 0V, and having a 1:2 ratio between the pulse durations of the negative pulse 44 and the positive pulse 46, i.e. the positive pulse 46 is of twice the duration of the negative pulse 44. By applying the second droplet ejection pulse 46 after the first droplet ejection pulse 44, the field applied across a wall changes direction. It will be appreciated that the field also changes direction when a positive droplet ejection pulse is followed by a negative droplet ejection pulse. The combination of the two pulses of opposite sign causes ejection of a droplet. The first droplet ejection pulse 44 for example may generally have the purpose of deforming the walls of the chamber outwardly so as to draw fluid into the chamber, and the second droplet ejection pulse 46 may generally have the purpose of deforming the walls of the chamber 110 inwardly. As the first pulse 44 returns to the reference voltage (and the walls towards the neutral state), the pressure in the chamber 110 increases and rises further as the voltage changes towards the maximum voltage of the second droplet ejection pulse 46, until a droplet is ejected from the nozzle 172.

In the drive waveform 40, the relative voltage seen by the wall sandwiched between two electrodes has been depicted rather than the absolute voltage signals applied to the electrodes; hence the drive waveform has a relative minimum voltage of −20V and a relative maximum voltage of +20V. Such a relative voltage may be achieved by applying different absolute voltages across a chamber wall, as is well known. A change in sign of the voltage across the wall may be denoted in FIG. 2 and the following Figures as “relative voltage” VR about a reference voltage, in the following the reference voltage is 0V. Depending on the drive circuit of the electrodes however, the value of the reference voltage and the absolute (peak amplitude) value may be different while deforming the walls in the same manner and generating an equivalent relative voltage VR as shown in FIG. 2. In FIG. 2, the chamber pressure resulting from the application of the waveform 40 is superimposed by a dashed line onto the drive waveform 40. The chamber pressure can be seen to persist after the drive waveform has been applied. Such pressure fluctuations may propagate through the common manifold and into neighbouring chambers. Depending on their amplitude, in some cases such fluctuations may affect the pressure in neighbouring chambers significantly enough to cause accidental droplet ejection from the neighbouring chambers. These fluctuations may be managed by cancellation pulses applied after the droplet ejection pulses, so that the next drive waveform can be applied as soon as possible. This allows higher frequency operation with reliable droplet ejection.

At the same time, the power consumption over a given time frame is increased and more heat is generated by for example the drive circuitry. Therefore, there is a need for improved drive waveforms and methods and controllers to generate and apply such waveforms to lower energy consumption and heat generation in droplet ejection heads.

### SUMMARY

Aspects of the invention are set out in the appended independent claims, while particular embodiments of the invention are set out in the appended dependent claims.

The following disclosure describes, according to a first aspect of the invention, a method for providing a drive waveform for a droplet ejection apparatus, the method comprising the steps of:
(a) receiving a nominal drive waveform comprising a droplet ejection pulse having a nominal maximum amplitude Vmax(nominal) and for achieving a nominal droplet velocity vel(nominal); and further comprising a nominal non-ejecting pulse ahead of the droplet ejection pulse, wherein the non-ejecting pulse is spaced apart from the droplet ejection pulse by a first delay d1;
(b) receiving a target droplet velocity vel(target) and/or a target maximum amplitude of the droplet ejection pulse Vmax(target);
(c) adjusting one or more waveform parameters on the basis of the received vel(target) and/or Vmax(target) to provide an adjusted drive waveform to achieve at least one of vel(target) and Vmax(target); and
(d) outputting the adjusted drive waveform.

According to a second aspect of the invention, a method is provided for operating a droplet ejection apparatus, the droplet ejection apparatus comprising an actuator element of the droplet ejection apparatus, the actuator element bounding in part a pressure chamber, the pressure chamber being in fluidic communication with a nozzle, the actuator element arranged to deform so as to cause a droplet to be ejected from the nozzle; the method comprising providing an adjusted drive waveform to the actuator element, wherein the adjusted drive waveform comprises a droplet ejection pulse and a non-ejecting pulse arranged ahead of the droplet ejection pulse, wherein the first delay and/or the duration of the non-ejecting pulse is such that the non-ejecting pulse causes a priming pressure in the chamber; the priming pressure being below that which causes ejection of the droplet and the droplet ejection pulse causes the ejection of the droplet after the droplet ejection pulse further increases the priming pressure in the chamber to a droplet ejection pressure.

In certain embodiments, the droplet ejection apparatus includes a fluid for ejection, wherein the fluid has a viscosity greater than 10 mPas.

Further provided is a computer program configured to carry out the above methods.

Further provided is a controller for a droplet ejection apparatus, the controller being configured to carry out the above methods.

Further provided is a droplet ejection apparatus comprising a controller configured to carry out the above methods.

### BRIEF DESCRIPTION OF THE DRAWINGS

Reference is now directed to the drawings, in which:

FIG. 1 is a schematic cross-section of a known droplet ejection head;

FIG. 2 is an example of a conventional drive waveform;

FIG. 3 is a flow chart illustrating the method steps of generating the adjusted drive waveform

FIG. 4 is a block diagram of a droplet ejection apparatus according to the present invention;

FIG. 5 is a block diagram of a droplet ejection apparatus and a controller according to the present invention;

FIG. 6A illustrates a nominal drive waveform comprising a positive pre-pulse and a first and second droplet ejection pulse and that is to be adjusted according to the invention;

FIGS. 6B and 6C show an adjusted drive waveform based on the nominal drive waveform of FIG. 6A;

FIG. 7A illustrates a nominal drive waveform comprising a negative pre-pulse and a first and second droplet ejection pulse and that is to be adjusted according to the invention;

FIGS. 7B and 7C show an adjusted drive waveform based on the nominal drive waveform of FIG. 7A;

FIG. 7D is a plot of percentage change in maximum chamber pressure compared to the basic drive waveform of FIG. 2 when changing one waveform parameter;

FIG. 8A is a standard trapezoidal drive waveform;

FIG. 8B is a plot of average droplet velocity versus frequency for the waveform shown in FIG. 8A;

FIG. 8C is a plot of average droplet volume versus frequency for the waveform shown in FIG. 8A;

FIG. 8D shows a pre-pulsed drive waveform;

FIG. 8E is a plot of average droplet velocity versus frequency for the waveform shown in FIG. 8D;

FIG. 8F is a plot of average droplet volume versus frequency for the waveform shown in FIG. 8D;

FIG. 9A shows a pre-pulsed drive waveform and a chamber pressure at low frequency;

FIG. 9B shows a pre-pulsed drive waveform and a chamber pressure at a frequency which is higher than that of FIG. 9A;

FIG. 9C shows a pre-pulsed drive waveform and a chamber pressure at a frequency which is higher than that of FIG. 9B;

FIG. 10A is an adjusted drive waveform comprising a positive pre-pulse and a negative post-pulse according to a variant of FIG. 6B;

FIG. 10B is an adjusted drive waveform comprising a negative pre-pulse and a positive post-pulse according to a variant of FIG. 7B;

FIG. 10C is an adjusted drive waveform comprising a negative pre-pulse and a negative post-pulse according to a further variant of FIG. 7B; and

FIG. 11 is a plot of percentage change in maximum chamber pressure compared to the basic drive waveform of FIG. 2 altering two waveform parameters.

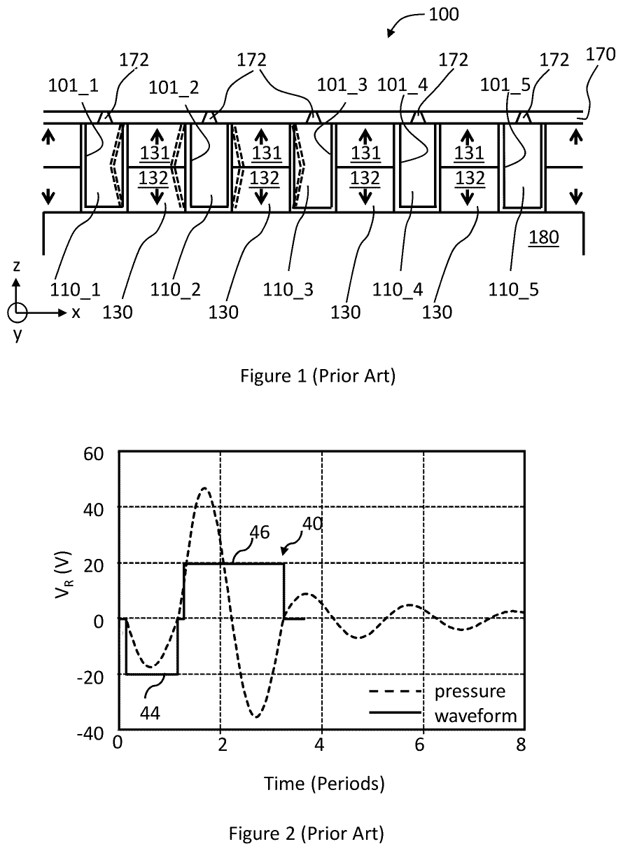

In the Figures, like elements are indicated by like reference numerals throughout.

### DETAILED DESCRIPTION

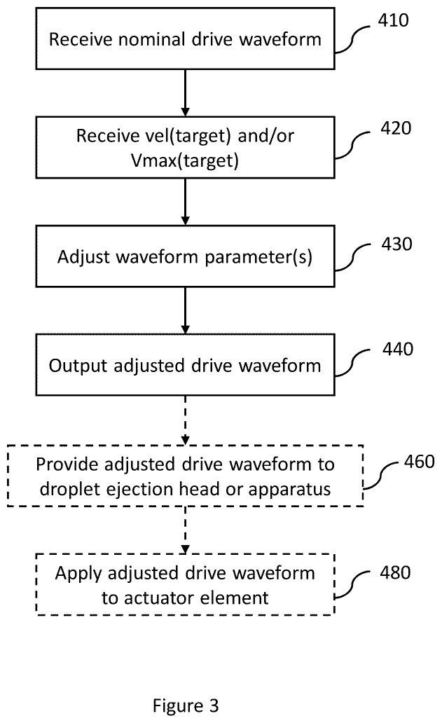

The methods and controllers carrying out the methods of the present disclosure address the above mentioned problems and provide adjusted drive waveforms capable of a more efficient operation of the droplet ejection head and suitable to reduce power consumption and heat generation in droplet ejection apparatus, as will now be illustrated with respect to several embodiments and their variants and with reference to FIGS. 3 to 8C. In the following, an actuating element comprises a piezoelectric material and a pair of electrodes which, upon being addressed by appropriate respective drive signals forming part of a drive waveform, apply an electric field across the piezoelectric material so that it deforms and causes the ejection of a droplet.

Generally, improved drive waveforms, herein called “adjusted” drive waveforms, may be generated and applied to each actuating element by circuitry within the droplet ejection apparatus and according to a method that may be separated into two overall activities: one of generating an adjusted drive waveform, and one of applying the adjusted drive waveform to an actuating element of a droplet ejection apparatus. Accordingly, for the generation of adjusted drive waveforms, a method is provided for providing a drive waveform for a droplet ejection apparatus, the method comprising the steps of:
receiving a nominal drive waveform comprising a droplet ejection pulse having a nominal maximum amplitude Vmax(nominal) and achieving a nominal droplet velocity vel(nominal); and further comprising a nominal non-ejecting pulse ahead of the droplet ejection pulse, wherein the non-ejecting pulse is spaced apart from the droplet ejection pulse by a first delay d1;
receiving one of a target droplet velocity vel(target) and/or a target maximum amplitude of the droplet ejection pulse Vmax(target);
adjusting one or more waveform parameters on the basis of the received vel(target) and/or Vmax(target) to provide an adjusted drive waveform to achieve at least one of vel(target) and Vmax(target); and
outputting an adjusted drive waveform.

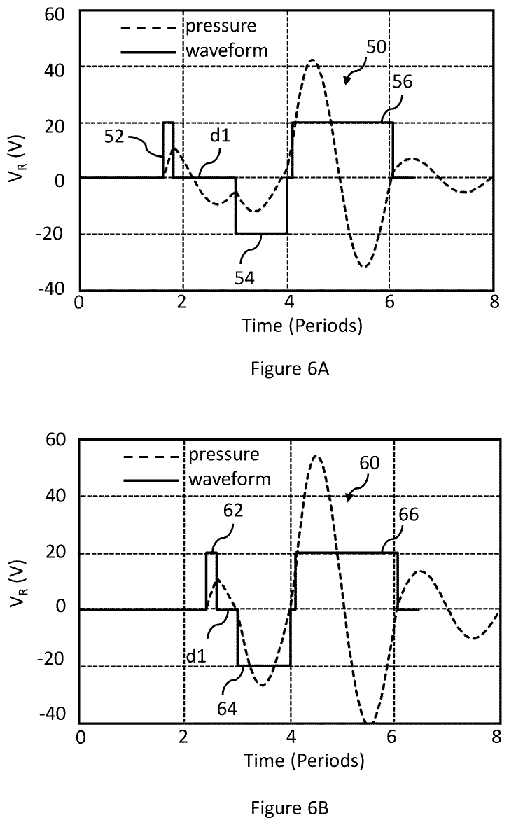

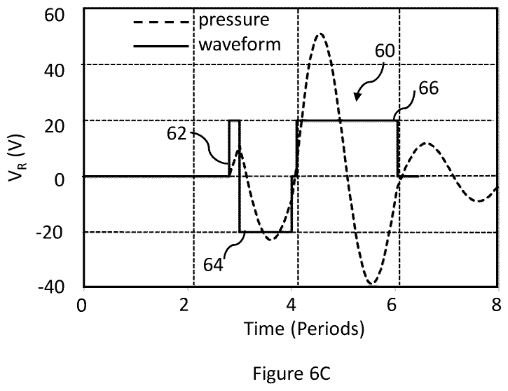

These steps are illustrated by the flow chart in FIG. 3 and will be further described with reference to FIGS. 6A and 6B. The blocks of the flow chart may be carried out by a computer program, or by a controller comprising a suitable program either external to or internal of the droplet ejection apparatus.

At block 410, a nominal drive waveform 50 is received by the controller, which may be a starting point waveform for example as illustrated in FIG. 6A (which will be described more fully below). The nominal drive waveform 50 comprises a nominal droplet ejection pulse (exemplified here as a first and second droplet ejection pulse 54, 56, similar to that shown in FIG. 2; however a single droplet ejection pulse may be used as an alternative) and a nominal non-ejecting pulse 52 arranged ahead of the droplet ejection pulse. Such a non-ejecting pulse, arranged ahead of the droplet ejection pulse, may be referred to herein as a “pre-pulse”. The provision of the pre-pulse 52 may simply be by provision of waveform parameters that allow adding such a pre-pulse to the waveform during the adjustment step i.e. it is not strictly necessary that the pre-pulse has an amplitude different to the reference voltage of the nominal drive waveform. The nominal drive waveform 50 is a waveform that is to be adjusted so as to make the operation of the actuating element more efficient and so as to reduce power consumption and heat generation of the droplet ejection apparatus. This may be achieved by adjusting the nominal drive waveform so as to obtain at least one of a target droplet velocity vel(target) or a target maximum amplitude Vmax(target) of the droplet ejection pulse or of the drive waveform.

Therefore, at block 420, a target velocity vel(target) of the ejected droplets is provided, and/or a target maximum amplitude Vmax(target) of one or both of the droplet ejection pulse or of the drive waveform is provided to the controller.

At block 430, the controller carries out an algorithm to adjust one or more parameters of the drive waveform so as to arrive at an adjusted drive waveform 60 that achieves at least one of the target velocity vel(target) of the ejected droplets and the target maximum amplitude Vmax(target) of one or both of the droplet ejection pulse or of the drive waveform. The adjusted drive waveform 60 is one that represents an improvement over the basic drive waveform 40 shown in FIG. 2 and which does not have a pre-pulse, where ‘improvement’ means moving towards, or achieving, a target value of at least one of resulting droplet velocity and waveform or droplet ejection pulse amplitude.

In the embodiments of the invention, at least one non-ejecting pulse (referred to as a pre-pulse herein) is applied before the droplet ejection pulse. Non-ejecting pulses do not lead to the ejection of a droplet. Pre-pulses referred to herein are adjusted to affect the droplet velocity of the ejected droplets. This may in turn be used to lower the amplitude of the droplet ejection pulses, or of the drive waveform, so as to reduce power consumption and heat generation by drive circuitry. By providing a pre-pulse ahead of a droplet ejection pulse in a drive waveform, and by suitably adjusting one or more of the waveform parameters of the drive waveform, the adjusted drive waveform may achieve vel(target) at an adjusted maximum amplitude of the droplet ejection pulse lower than Vmax(nominal) of the droplet ejection pulse.

At step 440, the controller outputs the adjusted drive waveform 60. Optionally, the controller may, at block 460, provide the adjusted drive waveform 60 to the droplet ejection apparatus, and, at block 480, apply the adjusted drive waveform 60 to the actuator element of the droplet ejection apparatus. Alternatively, the controller may provide the adjusted drive waveform 60 to drive circuitry within or associated with the droplet ejection apparatus, which in turn provides the drive waveform 60 to the actuation element of the apparatus. In other words, one or both of steps 460 and 480 may be carried out by circuitry distinct from the controller.

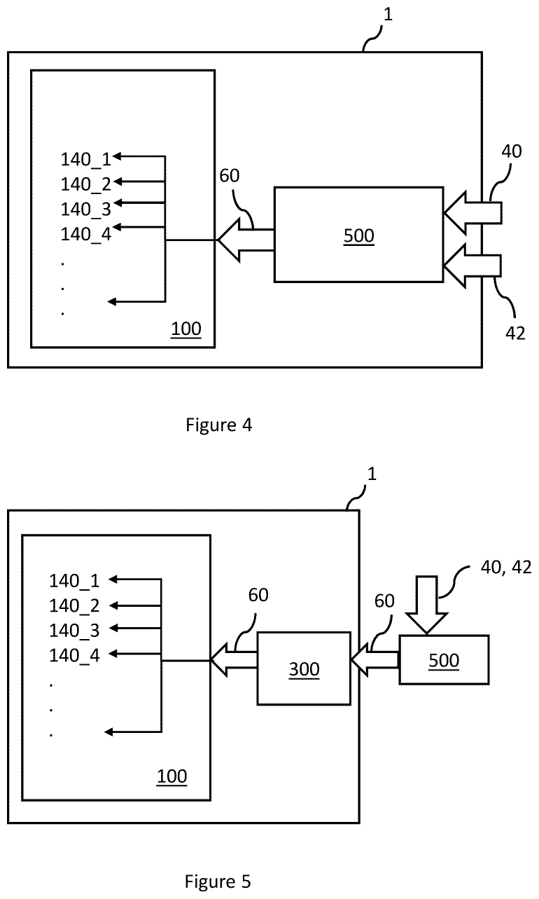

Locations of a controller capable of providing adjusted drive waveforms 60 are illustrated with respect to droplet ejection apparatus 1 in FIGS. 4 and 5 by way of block diagrams. In FIG. 4, the controller 500 is onboard the droplet ejection apparatus 1 and able to execute the program to generate adjusted drive waveforms 60. The controller 500 provides the adjusted drive waveforms 60 to the actuating elements 140_1, 140_2, 140_3, . . . of a droplet ejection head 100. Data 42 may comprise image data based on which the controller 500 supplies the adjusted drive waveforms 60 to the actuating elements 140. In FIG. 5, the controller 500 is located external to the droplet ejection apparatus 1 and generates adjusted drive waveforms 60 external from the apparatus 1. The controller provides the adjusted drive waveforms 60 to a drive circuit or onboard controller 300, which in turn, based on image data, the circuit or controller 300 provides to the actuating elements 140_1, 140_2, 140_3, . . . of a droplet ejection head 100. For example, data 42 may comprise image data the controller 500 supplies to the circuit or onboard controller 300. The controller 500 is configured to be in communication with the droplet ejection apparatus 1 and to control the functioning of various components of the droplet ejection apparatus 1, and to control the droplet ejection.

The drive circuit 300 may be configured to generate the improved drive waveform 60, or it may be configured to receive the improved drive waveform 60 from the controller 500. The drive circuit 300 may be external to the droplet ejection head 100, in the form of a separate circuit board such as a driver board, or the drive circuit may be comprised in the droplet ejection head 100.

Therefore, the adjusted drive waveforms 60 may be generated externally to the droplet ejection head 100 or within the droplet ejection head 100, e.g. in an Application Specific Integrated Circuit (ASIC), or a control circuit located within the droplet ejection head 100.

The one or more waveform parameters that are being adjusted to provide the adjusted drive waveform 60 may comprise the first delay d1, a duration of the non-ejecting pulse, a maximum amplitude of the non-ejecting pulse, a duration of one or more droplet ejection pulses and a maximum amplitude of the droplet ejection pulse, etc.

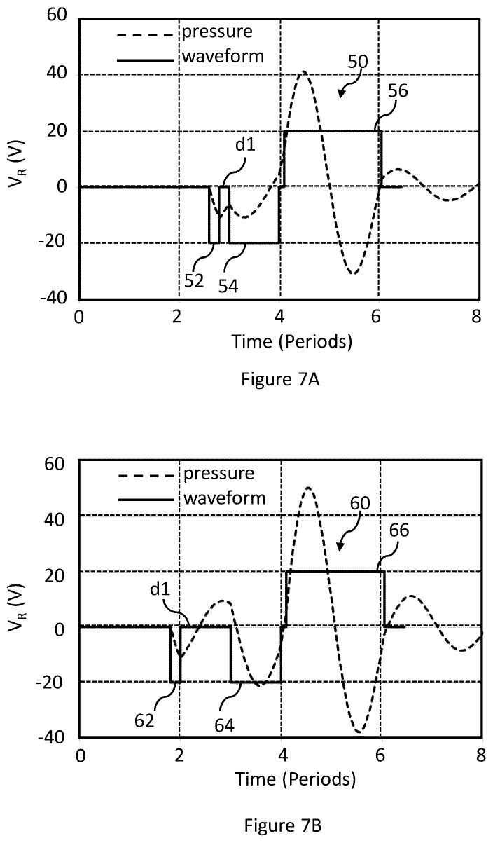

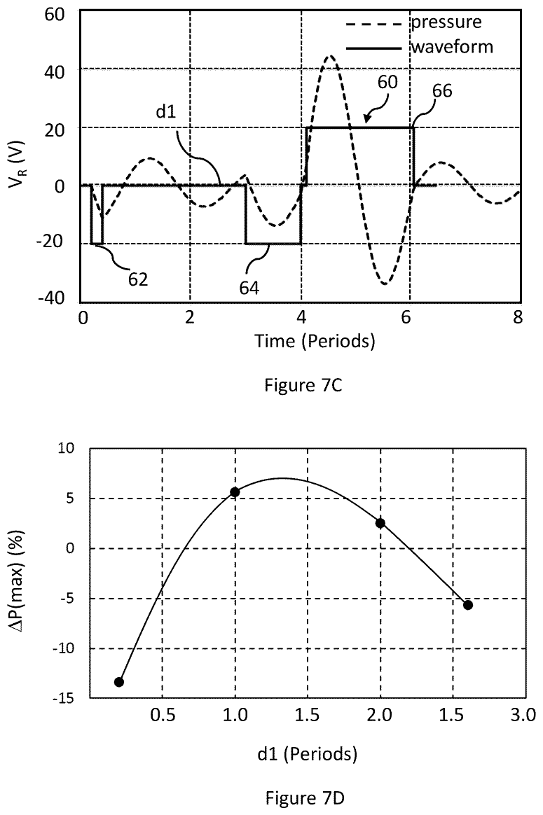

Some of such waveform parameters will be described with reference to the drive waveforms and pressure curves illustrated in FIGS. 6A to 6C for provision of a positive pre-pulse and in FIGS. 7A to 7D for provision of a negative pre-pulse.

In these and subsequent Figures illustrating drive waveforms 60 and chamber pressure, the drive waveforms are shown as solid lines and the chamber pressure is superimposed as a dashed line, and both are obtained by modelling based on example pressure chamber dimensions. Actual values are expected to vary for a specific pressure chamber design, however similar trends in findings may be expected.

A non-ejecting pulse applied before the droplet ejection pulses will be referred to as a “pre-pulse” and a non-ejecting pulse applied after the droplet ejection pulses will be referred to as a “post-pulse”. The pulses of the waveforms are shown as positive and negative pulses, in terms of their polarity with respect to a reference voltage, as previously mentioned the reference voltage may or may not be at 0V, and pulses are also referred to as being inverted with respect to one another, referring to the polarity of the pulses.

In a first embodiment of applying a positive pre-pulse, FIGS. 6B and 6C show adjusted drive waveforms 60 over a nominal drive waveform which may for example be the nominal drive waveform shown in FIG. 6A, although any other starting point is possible. For example, the aim may be to provide a faster droplet velocity vel(target) over a droplet velocity resulting from a waveform that does not have a pre-pulse, such as basic drive waveform 40 in FIG. 2. The rise in chamber pressure at or near the rising edge of the second droplet ejection pulse 66 and the resulting peak height in chamber pressure may be used as an indication for resulting droplet velocity. The nominal drive waveform 50 of FIG. 6A provides a pre-pulse 52 with a delay d1 that is similar in duration to that of the first droplet ejection pulse 54. The resulting chamber pressure reaches a maximum that is lower than that of the basic drive waveform 40 of FIG. 2. This waveform is therefore not expected to provide an enhanced droplet velocity. In FIGS. 6B and 6C, the delay d1 is adjusted while the pulse durations of the pre-pulse 62 and the first and second droplet ejection pulses 64, 66 remain the same compared to the pre-pulse 52 and the first and second droplet ejection pulses 54, 56.

The inventors have found that by selecting a suitably shortened delay d1, the increase in pressure by positive pre-pulse 62 may be used to reduce the maximum drive voltage of the drive waveform, and achieving a target velocity at a lower maximum drive voltage. This is illustrated in FIG. 6B, in which the pre-pulse delay d1 is shorter than the pre-pulse delay d1 of the nominal drive waveform 50, and in FIG. 6C, the pre-pulse delay d1 is zero. Both resulting pressure curves show an increase in the maximum chamber pressure upon application of the second droplet ejection pulse 66, where the maximum chamber pressure for the shorter d1 in FIG. 6B is significantly increased over that in FIG. 6A and comparable to that in FIG. 6C. Moving the pre-pulse 62 closer to the first droplet non-ejecting pulse 64 but still having a non-zero delay d1 in the example as shown in FIG. 6B was found to lead to a significant increase in chamber pressure. It can therefore be seen that by choosing the delay d1 as a waveform parameter, adjusted drive waveforms 60 may be obtained that may achieve a vel(target). In this embodiment, keeping all other waveform parameters constant, a delay d1 that is a fraction of the first droplet ejection pulse duration may result in a significant increase in droplet velocity.

In the case of a positive pre-pulse (i.e. a pre-pulse of the same polarity as the second droplet ejection pulse 66), the delay d1 may have a duration that is up to 60% of the duration of the first droplet ejection pulse 64, and preferably up to 50%, and more preferably up to 45%. In the example of FIG. 6B, the delay d1 is around 40% of the duration of the first droplet ejection pulse 64 and provides an increase in chamber pressure of around 15% compared to the basic drive waveform 40 of FIG. 2, while in the example of FIG. 6C, the delay d1 is zero and provides an increase in chamber pressure of around 8% compared to the basic drive waveform 40. In some preferred drive waveforms 60 therefore, the delay d1 may be substantially zero.

In some applications, where the aim is to reduce the maximum drive voltage, the enhanced chamber pressure may be traded off against lowering the drive voltage, achieving lower power consumption of the droplet ejection head and less heat generated by the drive circuit.

According to a second embodiment, a negative pre-pulse may be provided to the adjusted drive waveform 60. This is illustrated in FIGS. 7A to 7C. The nominal drive waveform may for example be nominal drive waveform 50 illustrated in FIG. 7A, in which a first and second droplet ejection pulse 54, 56 are shown, which are similar to those of the basic drive waveform 40 of FIG. 2. In addition, a negative pre-pulse 52 is provided spaced apart from the first negative droplet ejection pulse 54 by a delay d1. The delay d1 of the nominal drive waveform 50 is short, of the order of a fraction of the duration of the first negative droplet ejection pulse 54, and similar to the duration of the pre-pulse 52. In the example nominal drive waveform 50, the delay d1 and the pre-pulse duration are each around 20% of the duration of the first droplet ejection pulse 54. The resulting maximum pressure after application of the second droplet ejection pulse 56 is lower than the maximum pressure of the basic drive waveform 40. This waveform is therefore not expected to provide an enhanced droplet velocity. In FIGS. 7B and 7C, the delay d1 is adjusted while the pulse durations of the pre-pulse 62 and the first and second droplet ejection pulses 64, 66 remain the same compared to the pre-pulse 52 and the first and second droplet ejection pulses 54, 56.

In FIG. 7B, the delay d1 is the same as the duration of the first droplet ejection pulse 64 and the adjusted drive waveform 60 results in an improved maximum pressure. The extended delay d1 compared to the short delay d1 of FIG. 7A allows the chamber pressure to develop before the droplet ejection pulses are applied, and provides enhanced droplet velocity. The increase in maximum chamber pressure is 5.6% over that of the basic drive waveform 40. FIG. 7C shows that when the delay d1 is lengthened to around 2.6 times the duration of the first droplet ejection pulse 64, the maximum pressure is decreased by around 5.6% compared to the basic drive waveform 40.

The results from models including the results shown in FIGS. 7A to 7C are plotted in FIG. 7D, which plots the pre-pulse delay d1 against ΔP(max), the percentage change in maximum chamber pressure with respect to the maximum pressure resulting from the basic drive waveform 40 of FIG. 2. In the plot, the delay d1 is normalised against the duration of the first droplet ejection pulse 64, where the duration of the first droplet ejection pulse 64 is equal to one “period”. The plot of FIG. 7D suggests that there is an optimum delay d1 that ranges from around 1 to 1.5 periods for which a maximum pressure at droplet ejection may be obtained. As was found for the positive pre-pulse, by choosing the delay d1 as a waveform parameter, adjusted drive waveforms 60 may be obtained that may achieve an increased droplet velocity vel(target) which may optionally be traded off against a decrease in maximum amplitude of the pulses of the waveform.

For comparison, to illustrate adjusting two waveform parameters in combination, the pre-pulse duration may be optimised for a range of pre-pulse delays d1. The resulting percent change in maximum chamber pressure compared to the maximum pressure of the basic drive waveform 40 of FIG. 2 is plotted in FIG. 11. As for FIG. 7D, the delay d1 and the duration of the pre-pulse 62 were normalised against the duration of the first droplet ejection pulse 64. The plot suggests that, based on the modelled results, a pressure increase of almost 40% may be obtained if the pre-pulse duration is also adjusted. The values based on modelling are plotted in Table 1. For example, for pre-pulse delays d1 ranging from 0.6 to 1.1 periods, adjusting the duration of the pre-pulse to be from 1.5 periods to 0.5 periods, an improvement of 25% or more may be obtained for the maximum chamber pressure.

Therefore, the waveform parameter to be adjusted may comprise at least the pre-pulse delay d1 and the pre-pulse duration to arrive at improved droplet velocities. Where the non-ejecting pulse 62 is a negative non-ejecting pulse (i.e. a negative pre-pulse), a delay d1 of 0.4 to 1.3 durations of the first droplet ejection pulse 64 and a pre-pulse duration of 1.9 durations of the first droplet ejection pulse 64 or less may provide an enhanced chamber pressure, and thus an enhanced droplet velocity. Suitable combinations may result in a pressure enhancement by up to 37% of the maximum pressure compared to the basic drive waveform 40 not having a negative pre-pulse.

TABLE 1
data points of FIG. 11

| | | Pre-pulse |
|---|---|---|
| d1(periods) | ΔP(max)(%) | duration (periods) |
| 0.4 | 0 | 1.9 |
| 0.5 | 14 | 1.7 |
| 0.6 | 25 | 1.5 |
| 0.7 | 33 | 1.3 |
| 0.8 | 37 | 1.1 |
| 0.9 | 37 | 0.9 |
| 1.0 | 34 | 0.7 |
| 1.1 | 27 | 0.5 |
| 1.2 | 16 | 0.3 |
| 1.3 | 0 | 0 |

Preferred combinations may comprise a delay d1 ranging from 0.6 to 1.1 durations of the first droplet ejection pulse 64 and a pre-pulse duration ranging from 1.5 to 0.5 durations of the first droplet ejection pulse 64. Suitable combinations may result in a pressure enhancement by 25%-37% of the maximum pressure compared to the basic drive waveform 40 not having a negative pre-pulse. Suitable combinations that comprise a delay d1 ranging from 0.8 to 0.9 durations of the first droplet ejection pulse 64 and a pre-pulse duration of 1.1 to 0.9 durations of the first droplet ejection pulse 64 may result in a pressure enhancement by at least 37%.

Further waveform parameters comprise parameters that define the shape and size of all pulses of the drive waveform, such as the pre-pulse duration, the pre-pulse amplitude and/or shape, and the duration, shape and/or amplitude of the first and second droplet ejection pulses. In addition, the first and second droplet ejection pulses may be spaced apart by a delay d2, which in FIGS. 6A to 7C is shown to be minimal.

The pre-pulse 62 may have the opposite or the same polarity of the second droplet ejection pulse 66. By adjusting the non-ejection delay d1 between a negative pre-pulse 62 and a negative droplet ejection pulse 64, the droplet velocity may be adjusted. Furthermore, it was found that a required droplet velocity may be achieved by controlling the duration of the second droplet ejection pulse 66 and the intermediate delay d2 between the first droplet ejection pulse 64 and the second droplet ejection pulse 66.

As has been illustrated with respect to the embodiments and their variants in FIGS. 6A to 7D, the adjusted drive waveform 60 may comprise an adjusted first delay d1. Some variants of the adjusted drive waveform 60 may comprise an adjusted first delay d1, and an adjusted maximum amplitude of the second droplet ejection pulse 66 that is lower than the maximum amplitude of the nominal drive waveform 50, Vmax(nominal).

Where the non-ejecting pulse is a negative pre-pulse, i.e. is inverted with respect to the droplet ejection pulse, or the second droplet ejection pulse 66, the delay d1 may range from 1 to 1.5 times the duration of the droplet ejection pulse, or of the first droplet ejection pulse 64. Where the non-ejecting pulse is a positive pre-pulse, i.e. is of the same polarity as the droplet ejection pulse, or the second droplet ejection pulse 66, the first delay may be less than 50% of the duration of the droplet ejection pulse, or the first droplet ejection pulse 66. In some variants, the first delay d1 of a positive pre-pulse may be substantially zero.

The amplitude of the non-ejecting pulse (positive or negative pre-pulse 62) may be lower than the maximum amplitude of the droplet ejection pulse 64, 66.

Some applications use high viscosity fluid to print. It has been seen that at a range of low viscosities, for example 4-10 mPas, a frequency response is flat to the applied drive waveform, providing consistent droplet velocity and droplet volume. However, as the viscosity of the fluid is increased, i.e. to greater than 10 mPas, the oscillations in the frequency response may be damped at low frequencies giving rise to stable or constant droplet velocity and droplet volume and at high frequencies, the frequency response may be changed, providing oscillations in droplet velocity and droplet volume. In particular, above a threshold viscosity, a transition in the droplet formation process may be observed which can result in a sharp rise in the droplet velocity and droplet volume at high frequency, giving unstable or oscillating droplet velocity and droplet volume. Moreover, as the viscosity of the fluid is increased further, i.e. to greater than 10 mPas, a threshold of this step change may move to lower frequencies such that there may be a small or no range of frequency over which the droplet velocity and droplet volume are constant.

It has been observed that when jetting a high viscosity fluid at high frequency, droplets remain attached to the nozzle via an extended ligature before the droplets break off. The term “high viscosity” as used herein should be understood as referring to a viscosity greater than 10 mPas. However, as the frequency is increased, more fluid is transferred into the extended ligature and therefore into the droplet such that when the droplets detach, droplet velocity and droplet volume are changed. Therefore, it is necessary to have a control of the droplet break off and in turn control of the droplet ejection so as to eject cleanly large and fast droplets over a wider range of frequencies.

The inventors have found that the addition of one or more non-ejecting pulses before the droplet ejection pulse (i.e. one or more pre-pulses) provides better and more consistent control of droplet ejection at high frequency, taking advantage of the ligature to pump more fluid into the droplet while it is still attached to the nozzle. Thus, for high viscosity fluids, such non-ejecting pulse(s) may improve droplet velocity and droplet volume of the droplets at high frequency. Further, such non-ejecting pulse(s) may enable the actuator to operate over a wider range of fluid viscosities with efficient ejection of large, fast and clean droplets at high frequency. Furthermore, with the one or more non-ejecting pulses before the droplet ejection pulse, it may also be possible to achieve higher droplet velocity at a comparatively lower voltage.

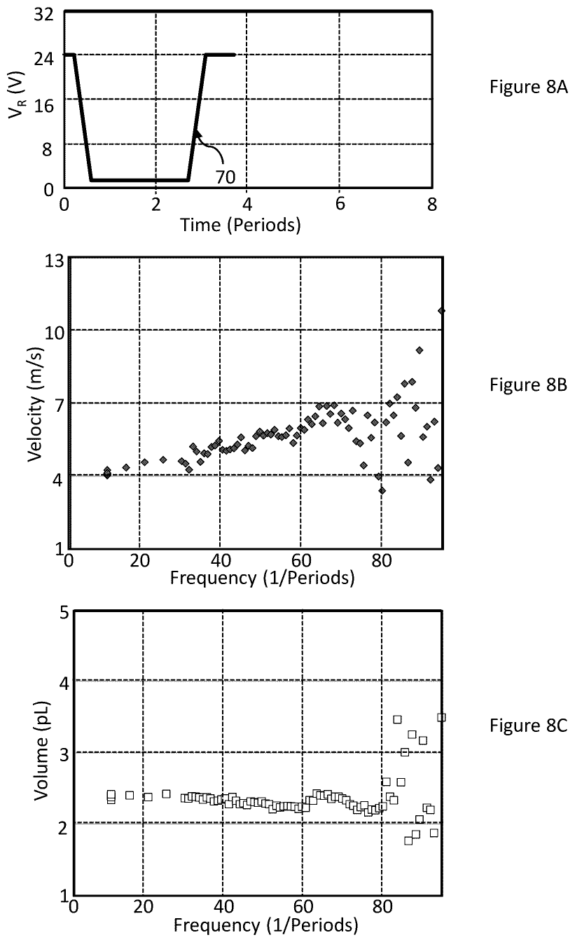

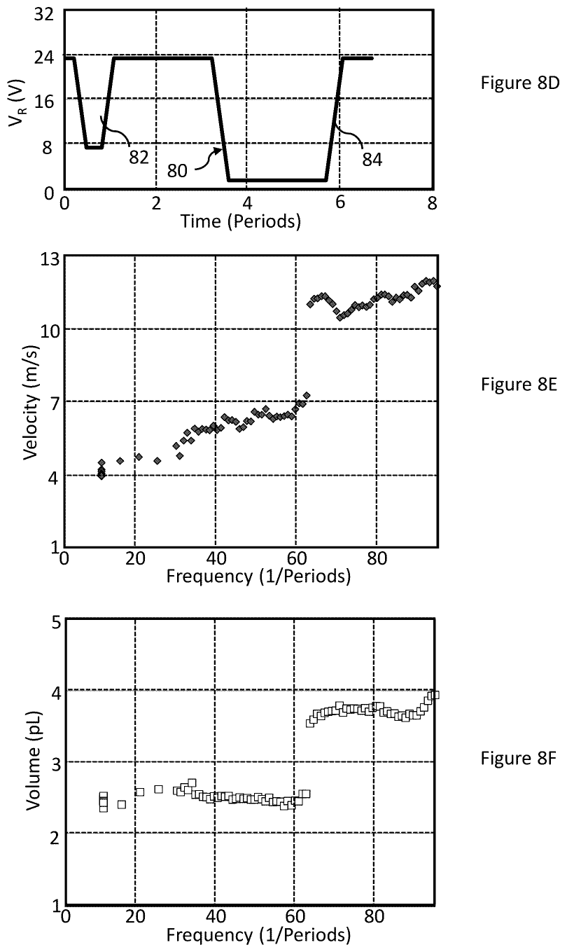

As an example, the frequency response for a fluid of viscosity 16.4 mPas is observed with the application of different drive waveforms as shown in FIGS. 8A to 8F. FIG. 8A shows a standard drive waveform 70 whereas FIG. 8D shows a drive waveform 80 with a non-ejecting pulse i.e. a negative pre-pulse 82 and a droplet ejection pulse 84. As shown in plots of FIG. 8B of average droplet velocity and of FIG. 8C of average droplet volume versus frequency, the response to a standard drive waveform 70 is heavily damped at high frequency resulting in scatter in the response curves with oscillations in the droplet velocity and droplet volume.

With the addition of one or more non-ejecting pulses 82 before the droplet ejection pulse 84, as shown in the plots of FIG. 8E of average droplet velocity and of FIG. 8F of average droplet volume versus frequency, the response is enhanced and a step change is observed from a low to a high frequency response such that a wider frequency window can be seen in which fast, large and clean droplets are efficiently ejected. Further, high droplet velocity, high droplet volume and satellite-free jetting with a flat frequency response is observed over a noteworthy range of frequencies. Thus, one or more non-ejecting pulses 82 before the droplet ejection pulse 84 enhances the jetting performance at high frequency. Moreover, with the addition of one or more pre-pulses 82, the voltage required for a target droplet velocity can be reduced. For example, to achieve the droplet velocity of 11-12 m/s, when a pre-pulsed drive waveform is used, the voltage required is approximately 22V, whereas when a standard drive waveform without a pre-pulse is used, the voltage required is approximately 28V. Thus, for a target droplet velocity, reduction in voltage can be achieved with the addition of one or more non-ejecting pulses before the droplet ejection pulse.

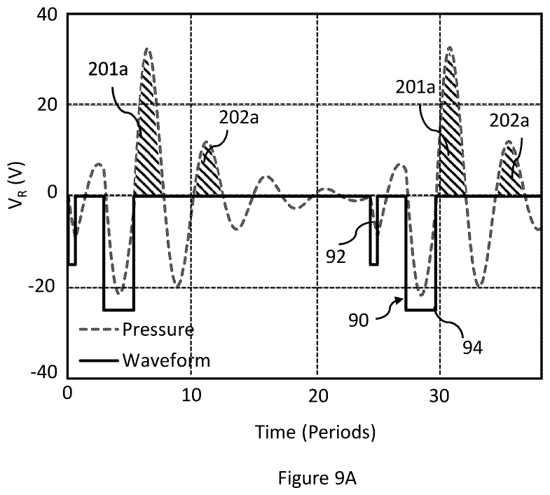

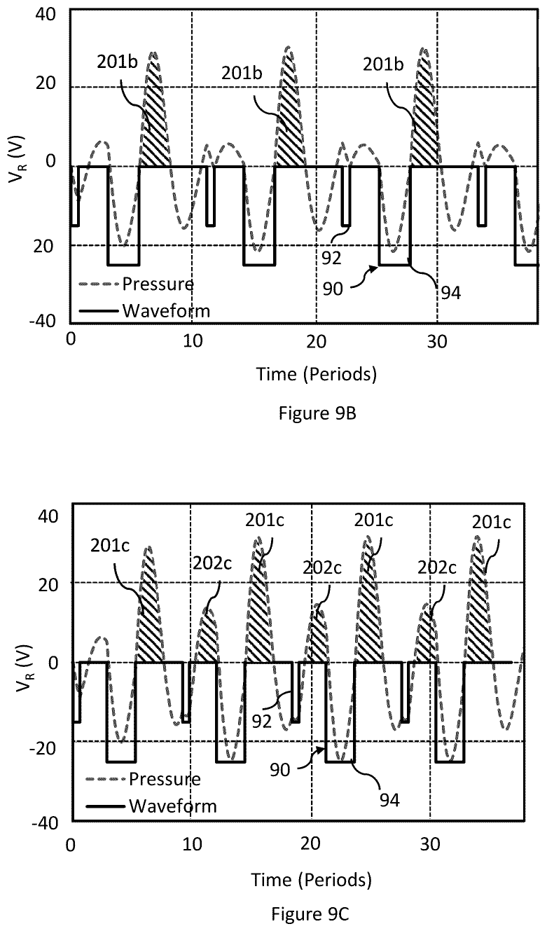

FIGS. 9A-9C show the effect of pre-pulsed drive waveforms 90, at different frequencies and corresponding chamber pressures. FIG. 9A shows a pre-pulsed drive waveform 90 and a chamber pressure at low frequency. The drive waveform 90 comprises a pre-pulse 92 and a droplet ejection pulse 94. At high viscosity, the droplet break off time is longer and the ligature persists for a time period that is comparable to the occurrence of the second positive lobe, lobe 2 (202a) in the channel response. For high viscosity, this second positive lobe, lobe 2 (202a) can contribute to the formation and improvement of the droplet before it breaks off. Therefore, in FIG. 9A, the highlighted or hashed region “Region (a)” is an area covered by a first positive lobe, lobe 1 (201a), and a second positive lobe, lobe 2 (202a), after the pre-pulsed drive waveform 90 and represents a measure of the droplet volume. In this, beyond a transition point where the ligature is still attached to the nozzle, droplet velocity and droplet volume can be enhanced using the pre-pulse such that the “Region (a)” —in particular, the second positive lobe, lobe 2 (202a), after the drive waveform—contributes to and boosts the droplet velocity and droplet volume.

In FIG. 9B, the frequency is higher than that of FIG. 9A. The highlighted region is shown as “Region (b)” (201b). As shown in FIG. 9B, the pre-pulse 92 for one droplet can act as a cancellation pulse for the preceding droplet. Further, the second positive lobe, lobe 2, as seen in FIG. 9A is dampened out and is not observed here, hence droplet velocity and droplet volume are reduced compared to FIG. 9A.

FIG. 9C shows a pre-pulsed drive waveform 90 and a chamber pressure at a frequency which is higher than that of FIG. 9B. The highlighted region is “Region (c)” and a constructive interference of the second positive lobe, lobe 2 (202c), is seen here. As shown in FIG. 9C, the pre-pulse 92 for one droplet acts as a reinforcing post-pulse (i.e. a non-ejecting pulse after the droplet ejection pulse) for the preceding droplet. Thus, the first and second positive lobes (201c, 202c) observed in “Region (c)” help to improve the droplet velocity and droplet volume.

Therefore, from the above FIGS. 9A-9C, it can be seen that, at relatively high frequencies, the pre-pulse 92 (i.e. the non-ejecting pulse before the droplet ejection pulse 94) acts as a cancellation pulse for the preceding droplet, hence negating some of the droplet velocity and droplet volume gain over lower frequency droplets. If the frequency is increased further, the pre-pulse acts as a reinforcing post-pulse (i.e. a non-ejecting pulse after the droplet ejection pulse) to boost the droplet velocity and droplet volume. Thus, the use of one or more non-ejecting pulses before the droplet ejection pulse is to actuate high viscosity fluid to eject large, fast and clean drops with increased droplet velocity.

Further, along with the frequency of the drive waveform, other waveform parameters such as the parameters that define the shape and size of all pulses of the drive waveform, such as the pre-pulse duration, the pre-pulse amplitude and/or shape, delay between the pre-pulse and the droplet ejection pulse, and the duration, shape and/or amplitude of the droplet ejection pulse, may also be adjusted to achieve a target droplet velocity and/or a target droplet volume.

It should be noted that even if FIGS. 8A to 8F depict a single pulse trapezoidal waveform 70/80, and FIGS. 9A-9C show a single pulse square waveform as a droplet ejection pulse 94, the invention is not limited to these waveforms. The droplet ejection pulse may take any shape or may take the same shape as the pulse as depicted in any of the FIGS. 6A-6C, 7A-7D.

It was found that typically pre-pulses arranged to enhance chamber pressure may also lead to larger and longer-persisting residual pressure variations after application of the droplet ejection pulses. The provision of a post-pulse 68 meanwhile may be used to reduce such pressure fluctuations that arise from droplet ejection, after the trailing edge of the droplet ejection pulse 66.

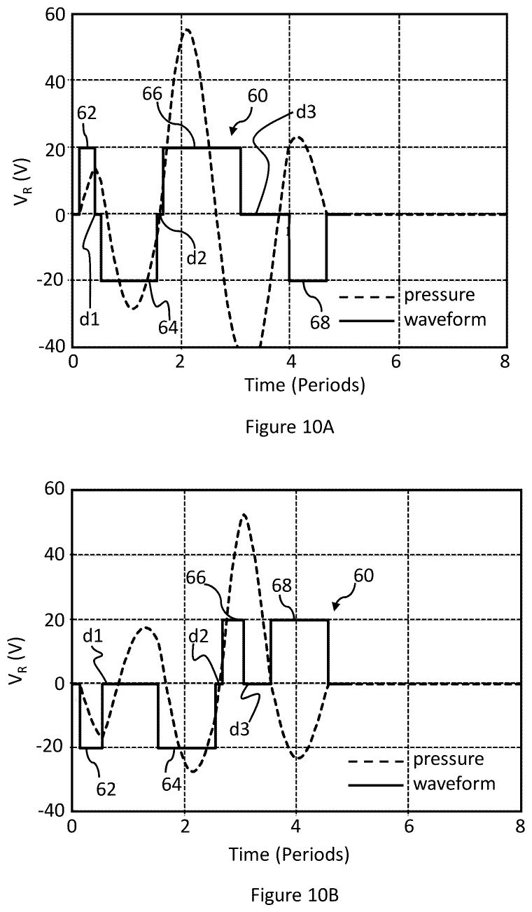

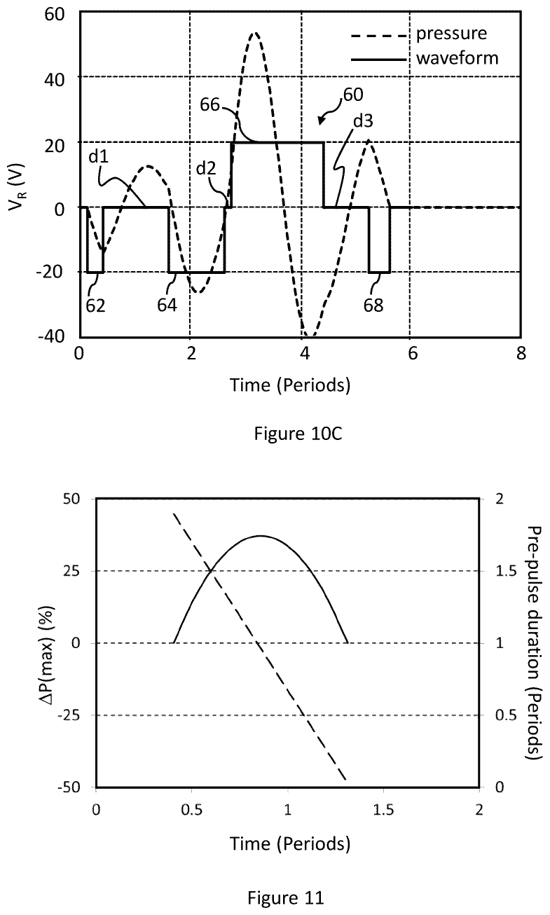

Several variants of the drive waveforms of FIGS. 6A to 7C will now be described that may reduce or prevent residual pressure fluctuations. With respect to FIG. 10A, a drive waveform comprising a positive pre-pulse similar to that in FIG. 6B is shown. The pre-pulse 62 is arranged with a delay d1 that is a fraction (around 10%) of the first droplet ejection pulse 64 duration. The pre-pulse 62 has a duration of around 27% of the duration of the first droplet ejection pulse 64. Compared to the adjusted drive waveform 60 of FIG. 6B, a negative post-pulse 68 is provided that is spaced from the second droplet ejection pulse 66 by a delay d3. In this variant, the pre-pulse delay d1 and intermediate delay d2 is adjusted so as to provide an increased maximum chamber pressure after the second droplet ejection pulse 66 is applied. This also leads to larger residual pressure fluctuations of longer duration, which are cancelled by suitably positioning the post-pulse 68, in FIG. 10A by destructively interfering with the second residual pressure peak following the droplet ejection peak. Since the post-pulse 68 is timed with respect to the second residual pressure peak, the delay d3 is relatively long compared to the duration of the post-pulse 68, and this adjusted drive waveform 60 variant has a longer duration compared to the one that will be described with reference to FIG. 10C, in which the post-pulse can interfere with the first residual pressure peak. Therefore, a positive pre-pulse 62 may be applied to provide an enhanced chamber pressure, while a negative post-pulse 68 may be applied to cancel residual pressure fluctuations.

A variant of the adjusted drive waveform 60 of FIG. 7B (having a negative pre-pulse) is shown in in FIG. 10B, wherein the adjusted drive waveform 60 comprises a first and second droplet ejection pulse 64, 66, a negative pre-pulse 62 and a positive post-pulse 68. The post-pulse 68 has the same polarity as that of the second droplet ejection pulse 66, whereas the pre-pulse 62 has the opposite polarity to that of the second droplet ejection pulse 66.

In comparison to FIG. 7B (showing a negative pre-pulse and no post-pulse), a positive post-pulse 68 is provided to cancel the first negative pressure peak following the positive pressure peak at droplet ejection. This is achieved by shortening the second droplet ejection pulse 66 to a duration similar to that of the pre-pulse 62, which allows the post-pulse to be applied as soon as possible after droplet ejection. As a result, the adjusted drive waveform 60 of FIG. 10B is able to offset the extended duration of delay d1 against the shortened pulse duration of the second droplet ejection pulse 66, maintaining the waveform at a similar overall duration.

Consequently the same approach may be used to shorten the adjusted drive waveform 60 of FIG. 10A: by shortening the second droplet ejection pulse 66 to a duration similar to that of the pre-pulse 62, and applying a positive and comparatively longer post-pulse 68 to the first residual pressure peak.

Therefore, a suitable adjustment of the duration of the pre-pulse 62 and of the delay d1 between the pre-pulse 62 and the first droplet ejection pulse 64 may be used to enhance droplet velocity and to allow a reduction in the maximum voltage required to achieve a target droplet velocity, while the duration of the second droplet ejection pulse 66, the duration of the post-pulse 68, and the post-pulse delay d3 between the second droplet ejection pulse 66 and the post-pulse 68 may be adjusted to reduce residual pressure oscillations at the end of the adjusted drive waveform 60.

A further variant of the adjusted drive waveform 60 of FIG. 7B is illustrated in FIG. 10C, wherein the adjusted drive waveform 60 comprises first and second droplet ejection pulses 64, 66 and two negative droplet non-ejecting pulses, pre-pulse 62 and post-pulse 68. The droplet non-ejecting pulses 62, 68 have opposite polarity to that of the second droplet ejection pulse 66.

Similar to FIGS. 7B and 10B, the extended delay d1 allows the chamber pressure to develop and provides enhanced droplet velocity, but instead of cancelling the first (negative) residual pressure peak after the positive ejection peak, a negative post-pulse 68 is applied to cancel the second (positive) residual pressure peak following the positive pressure peak at droplet ejection.

A suitable adjustment of the pre-pulse duration and of the delay d1 between the pre-pulse 62 and the first droplet ejection pulse 64 may enhance droplet velocity and thereby allow a reduction in the maximum voltage required to achieve a target droplet velocity. The duration of the delay d3 between the second droplet ejection pulse 66 and the post-pulse 68 may be adjusted to reduce residual pressure oscillations at the end of the adjusted drive waveform 60.

The variants of the adjusted drive waveform 60 as described in FIGS. 10A-10C form a subset of a variety of adjusted drive waveforms 60 and are for illustration purposes only. It should be noted that adjustment of the delay d2 between the first and second droplet ejection pulse 64, 66 may provide further enhancement to the adjusted drive waveform 60 according to the invention.

In variants of the embodiments therefore, the nominal drive waveform 50 and the adjusted drive waveform 60 may comprise a second non-ejecting pulse after the droplet ejection pulse, or after the second droplet ejection pulse 66, the second non-ejecting pulse spaced from the droplet ejection pulse, or the second droplet ejection pulse 66, by a third delay d3, and the waveform parameter comprises one or more of the third delay d3, a duration of the second droplet non-ejecting pulse and an amplitude of the second non-ejecting pulse. The adjusted drive waveform 60 may comprise a second non-ejecting pulse 68 after the droplet ejection pulse, or after the second droplet ejection pulse 66, the second non-ejecting pulse 68 spaced from the droplet ejection pulse, or the second droplet ejection pulse 66, by a third delay d3, wherein at least d3 is adjusted so as to reduce residual pressure fluctuations.

Therefore, the adjusted drive waveform 60 may further comprise one or more delays between successive ones of the pulses of the adjusted drive waveform 60, i.e. between successive ones of the one or more positive pulses and of the one or more negative pulses of the adjusted drive waveform 60. In some variants of the method, delays d1, d2, d3 between successive ones of the one or more positive pulses and of the one or more negative pulses may be adjusted such that residual pressure fluctuations resulting from the drive waveform are reduced. In other words, the incidence of each successive pulse, whether positive, negative or of the same sign compared to a preceding pulse, may need to be controlled. This means that the delay of a pulse is determined based on the required pulse duration and the pulse voltage of the preceding or subsequent pulse. The one or more delays between successive ones of the one or more positive pulses and of the one or more negative pulses may therefore be controlled such that residual pressure fluctuations resulting from supplying the drive waveform to the actuating element are reduced.

In some variants of the adjusted drive waveforms of FIGS. 6A to 7C, the above methods may comprise the steps of adjusting one or more of the pre-pulse delays d1, and the intermediate delays d2 between the one or more droplet ejection pulses 64, 66, so as to prevent residual pressure fluctuations. In some variants of the adjusted drive waveforms 60 of FIGS. 10A to 10C, the above methods may comprise the steps of adjusting in addition, or instead, a post-pulse delay d3 so as to prevent residual pressure fluctuations.

Optionally, where the nominal drive waveform 50 comprises two or more pre-pulses 52, the above methods may comprise the step of adjusting one or more delays d1 between successive ones of the pre-pulses 62 (between two pre-pulses, or between the pre-pulse 62 and a droplet ejection pulse) and reducing, based on the one or more delays d1, the maximum amplitude of the droplet ejection pulses required to achieve a target droplet velocity, vel(target).

Optionally, wherein the nominal drive waveform 50 comprises two or more post-pulses applied after the final (e.g. second) droplet ejection pulse of the drive waveform, the above methods may comprise the step of adjusting one or more delays d1, d3 between successive ones of each of the pulses 62, 64, 66, 68 (whether between two post-pulses, or between the post-pulse 68 and the final droplet ejection pulse 66), so to reduce or prevent residual pressure fluctuations in the fluid chamber 110.

A further waveform parameter may be the area (duration and amplitude, for example) and/or shape of each of the pulses so that the net area can be adjusted. The waveform parameter may for example comprises one or more of the areas of the first non-ejecting pulse 62, the second non-ejecting pulse 68, the first droplet ejection pulse 64 and the second droplet ejection pulse 66. In variants where further pulses are provided to the nominal drive waveform 50, the areas of each of the pulses may be comprised in the waveform parameter.

All non-ejecting pulses and all droplet ejection pulses of the drive waveform form one or more positive pulses and one or more negative pulses with respect to a reference voltage, wherein a net area is the resultant difference between the sum of the areas of all positive pulses and the sum of the areas of all negative pulses, so that the one or more non-ejecting pulses and the one or more droplet ejection pulses of the nominal drive waveform 40 represent a nominal net area Anet(nominal), and wherein the one or more non-ejecting pulses and the one or more droplet ejection pulses of the adjusted drive waveform 60 represent an adjusted net area Anet(adjusted), and wherein Anet(adjusted)<Anet(nominal). The reference voltage is the voltage level about which the pulses change in polarity, and in the Figures is shown as 0V. In other variants the reference voltage may be a different voltage.

The adjusted drive waveform 60 is provided to a droplet ejection apparatus 1 configured to apply the adjusted drive waveform 60 to one or more actuating elements 140, as indicated in blocks 460 and 480 of FIG. 3. Therefore, a method is provided for operating a droplet ejection apparatus 1 using an adjusted drive waveform 60 according to the invention. The droplet ejection apparatus 1 comprising an actuator element 140, the actuator element 140 bounding in part a pressure chamber, the pressure chamber being in fluidic communication with a nozzle 172, and the actuator element is arranged to deform so as to cause a droplet to be ejected from the nozzle. The method comprises the steps of:
providing an adjusted drive waveform to the actuator element 140, wherein the adjusted drive waveform comprises a droplet ejection pulse 64, 66 and a non-ejecting pulse 62 arranged ahead of the droplet ejection pulse,
wherein the first delay d1 and/or the duration of the non-ejecting pulse 62 is such that the non-ejecting pulse 62 causes a priming pressure in the pressure chamber and the droplet ejection pulse causes the ejection of the droplet after the droplet ejection pulse further increases the priming pressure in the chamber to a droplet ejection pressure. The priming pressure is a pressure at which no droplet is ejected.

In variants of the adjusted drive waveform 60 in which the droplet ejection pulse comprises a first droplet ejection pulse 64 and a second droplet ejection pulse 66, the second droplet ejection pulse 66 being inverted with respect to the first droplet ejection pulse 64, wherein the second droplet ejection pulse follows the first droplet ejection pulse 64 and causes the ejection of the droplet by further increasing the priming pressure in the chamber to a droplet ejection pressure.

In some variants of the adjusted drive waveform 60, the first delay d1 may be less than the duration of the non-ejecting pre-pulse 62. Optionally, or instead, the duration of the non-ejecting pre-pulse 62 may be substantially the same as the duration of the second droplet ejection pulse. In some variants of the adjusted drive waveform 60, the non-ejecting pre-pulse 62 and/or the non-ejecting post-pulse 68 may be inverted with respect to the droplet ejection pulse, or with respect to the second droplet ejection pulse 66.

The above methods of providing an adjusted drive waveform 60 may be carried out by a computer program configured to carry out the various methods described with respect to the above embodiments and their variants. The program may be provided by a controller 500, 300 configured to execute the computer program.

Furthermore, a droplet ejection apparatus 1 comprising a controller 300 is provided, the controller 300 configured to carry out the steps of providing an adjusted drive waveform 60 to the actuator element 140, wherein the adjusted drive waveform 60 comprises a droplet ejection pulse and a non-ejecting pulse 62 arranged ahead of the droplet ejection pulse, wherein the first delay d1 and/or the duration of the non-ejecting pulse 62 is such that the non-ejecting pulse 62 causes a priming pressure in the chamber, and the droplet ejection pulse causes the ejection of the droplet after the droplet ejection pulse further increases the priming pressure in the chamber to a droplet ejection pressure. The controller 300 may take the form of, or may comprise, a drive circuit.

### General Considerations

It should be appreciated that the adjusted drive waveforms 60, comprising a first and second droplet ejection pulses 64, 66 in the form of a negative pulse and a positive pulse, are illustrated in the Figures having a minimum relative voltage of −20V and maximum relative voltage of +20V for illustration purposes only. The adjusted drive waveform 60 is by no means limited to the shape or voltages of the pulses presented, and/or to the number and polarity of the pulses. The droplet ejection pulse may take any shape such as that of a trapezoidal, square, triangular, sawtooth or sinusoidal wave. Moreover, the droplet ejection pulse may comprise one or more of only positive pulses, only negative pulses, or any combination of positive and negative pulses.

The droplet ejection pulse shown in the FIGS. 6A and 6B and in subsequent Figures comprise a first and a second droplet ejection pulse 64, 66. A combination of first and second droplet ejection pulses may require an adjustment in the delay d2 between the two pulses. The intermediate delay d2 may therefore be a further waveform parameter. The adjusted drive waveforms 60 may be further modified by adjusting the intermediate delay d2 between droplet ejection pulses, or by applying additional non-ejecting pulses so as to reduce pressure fluctuations.

To maintain the total drive waveform duration the same as before the application of a pre-pulse, the duration of the pulse that deforms the wall of the chamber inwardly, in this case the second (here positive) droplet ejection pulse 66, may be adjusted together with the intermediate delay d2. However, there is a limit to which the pulse duration of the positive pulse 66 may be adjusted. The pulse duration of the positive pulse 66 may depend on various factors, such as fluid chamber geometry and fluid used for ejection. For example, when reducing the length of the fluid chamber along the direction of elongation (along y), the duration of the (positive) second pulse 66 may need to be reduced and therefore the intermediate delay d2 may need to be reduced. Meanwhile for a fluid chamber having an increased length along the direction of elongation (along y), the duration of the positive pulse 66 may need to be increased and the intermediate delay d2 may need to be increased. Furthermore, the pulse duration of second droplet ejection pulse 66 may also depend on the pulse duration of the first droplet ejection pulse 64. For example, if the pulse duration of the negative droplet ejection pulse 64 is larger than the pulse duration of the positive droplet ejection pulse 64, poor jetting behavior may result. It may be desirable to fix the duration of the negative pulse 64 and to adjust the pulse duration of the second droplet ejection pulse 66 in combination with the intermediate delay d2. This may lead to an improvement to the damping of the chamber pressure after the trailing edge of the second droplet ejection pulse 66.

The droplet ejection pulse may comprise a first droplet ejection pulse 64 and a second droplet ejection pulse 66, wherein the second droplet ejection pulse 66 follows the first droplet ejection pulse 64 after a second delay d2, and wherein the second droplet ejection pulse 66 is inverted with respect to the first droplet ejection pulse 64. The non-ejecting pulse 62 may be inverted with respect to the second droplet ejection pulse 66. Alternatively, the non-ejecting pulse 62 may be inverted with respect to the first droplet ejection pulse 64. In some variants where the droplet ejection pulse comprises a first and second droplet ejection pulse 64, 66, an intermediate delay d2 may be provided between the first and second droplet ejection pulse. Thus, the waveform parameter may comprise further a second, intermediate, delay d2 between the first and the second droplet ejection pulses 64, 66 and optionally further the duration of the second droplet ejection pulse.

The delay d1 between the pre-pulse 62 and the droplet ejection pulse may depend on the polarity and/or position of the pre-pulse 62 within the adjusted drive waveform 60. Optionally, the pre-pulse 62 may comprise more than one non-ejecting pulse, such as a first pre-pulse and a second pre-pulse. The duration of the pre-pulse 62 may be shorter than the duration of each first and second pulse 64, 66 in the droplet ejection pulse. However, this is not essential, alternatively, the duration of the pre-pulse 62 may be greater than the duration of at least one pulse 64, 66 in the droplet ejection pulse.

The above Figures illustrate adjusted drive waveforms 60 that may achieve a constant droplet velocity as a function of frequency and therefore as a function of media speed. The pulses of the drive waveform 60 may be adjusted or controlled such that the chamber pressure is reduced after the trailing edge of the drive waveform 60, reducing residual pressure fluctuations within the fluid chambers 110 and avoiding any adverse effects on a subsequent droplet from the same chamber or on a neighbouring chamber. Such improvements of the adjusted drive waveforms 60 may be beneficial for high frequency operation of a droplet ejection apparatus. However, it should be noted that the present invention is not limited to high frequency operation or the adjustment of pulse delays. For example, for low frequency operation, it may not be required to reduce residual pressure fluctuations to the same degree as for high frequency operation.

In addition, although the embodiments have been described with respect to an actuating element of a ‘bulk’ shared wall droplet ejection head, they are equally applicable to other droplet ejection head architectures, such as thin film MEMS or bulk roof mode actuators. The nominal and adjusted drive waveforms are further not limited to having a first and second droplet ejection pulse; in some variants, only one droplet ejection pulse may be applied to eject a droplet. Modifications to the embodiments and their variants to suit alternative waveforms and droplet ejection head architectures will be within the ability of the skilled person applying routine experimentation.

It should be appreciated that for ease of illustration, the Figures show the adjusted drive waveform as having one or more pulses of the same amplitude. However, the present invention is not limited to this and any amplitude of any of the pulses may be envisaged. Further, the droplet ejection pulses and the droplet non-ejecting pulses may have the same absolute amplitude or may have different absolute amplitudes. The amplitude of pulses may depend on the voltages supported by the drive circuitry. In the above illustrations, the reference voltage equals zero Volts. Alternatively, drive waveforms with a reference voltage of a different value may be envisaged. Furthermore, it is not necessary that the pulses of further variants of the embodiments described herein need be of different polarities; in some examples the pulses may all have the same polarity. Furthermore, simply for illustration purposes, the pulses are shown to be square pulses having the same amplitude, however this is not essential; instead one or more pulses may have different shapes and/or amplitudes compared to the other pulses.

The above embodiments and their variants described above may be used alone or in combination, as may be, to achieve improved drive waveforms 60 according to the invention for specific application requirements.

1. A method for providing a drive waveform for a droplet ejection apparatus, the method comprising the steps of:
receiving a nominal drive waveform comprising a droplet ejection pulse having a nominal maximum amplitude Vmax(nominal) and for achieving a nominal droplet velocity vel(nominal); and further comprising a non-ejecting pulse ahead of the droplet ejection pulse, wherein the non-ejecting pulse is spaced apart from the droplet ejection pulse by a first delay d1;
receiving a target droplet velocity vel(target) and/or a target maximum amplitude of the droplet ejection pulse Vmax(target);
adjusting one or more waveform parameters on the basis of the received target droplet velocity vel(target) and/or the target maximum amplitude of the droplet ejection pulse Vmax(target) to provide an adjusted drive waveform to achieve at least one of the target droplet velocity vel(target) and the target maximum amplitude of the droplet ejection pulse Vmax(target); and
outputting the adjusted drive waveform.

2. The method of claim 1, wherein the adjusted drive waveform achieves the target droplet velocity vel(target) at an adjusted maximum amplitude of the droplet ejection pulse lower than the nominal maximum amplitude Vmax(nominal) of the droplet ejection pulse.

3. The method of claim 1, wherein the one or more waveform parameters comprises the first delay, a duration of the non-ejecting pulse, a maximum amplitude of the non-ejecting pulse, a duration of the droplet ejection pulse and a maximum amplitude of the droplet ejection pulse.

4. The method according to claim 1, wherein the droplet ejection pulse comprises a first droplet ejection pulse and a second droplet ejection pulse, wherein the second droplet ejection pulse follows the first droplet ejection pulse after a second delay, and wherein the second droplet ejection pulse is inverted with respect to the first droplet ejection pulse.

5. The method according to claim 4, wherein the non-ejecting pulse is inverted with respect to the second droplet ejection pulse or with respect to the first droplet ejection pulse.

6. (canceled)

7. The method according to claim 4, wherein the waveform parameter comprises the second delay and the duration of the second droplet ejection pulse.

8. (canceled)

9. (canceled)

10. The method according to claim 9, wherein the adjusted drive waveform comprises an adjusted duration of the non-ejecting pulse that is similar to the duration of the second droplet ejection pulse.

11. The method according to claim 1, wherein the amplitude of the non-ejecting pulse of the adjusted drive waveform is lower than the maximum amplitude of the droplet ejection pulse of the adjusted drive waveform.

12. The method according to claim 1, wherein the non-ejecting pulse of the adjusted drive waveform is a non-ejecting pulse of the same polarity as the droplet ejection pulse, or the second droplet ejection pulse of the adjusted drive waveform, and wherein the first delay of the adjusted drive waveform is less than 50% of the duration of the droplet ejection pulse, or the first droplet ejection pulse of the adjusted drive waveform.

13. The method according to claim 12, wherein the first delay is substantially zero.

14. The method according to claim 1, wherein for the adjusted drive waveform the non-ejecting pulse is inverted with respect to the droplet ejection pulse, or the second droplet ejection pulse, and the adjusted duration d1 of the non-ejecting pulse ranges from 1 to 1.5 times the duration of the droplet ejection pulse, or first droplet ejection pulse.

15. The method according to claim 1, wherein the nominal drive waveform further comprises a second non-ejecting pulse arranged after the droplet ejection pulse, or after the second droplet ejection pulse, the second non-ejecting pulse spaced from the droplet ejection pulse, or the second droplet ejection pulse, by a third delay d3, wherein the third delay d3 is a waveform parameter and is adjusted so as to reduce residual pressure fluctuations.

16. The method according to claim 4, wherein the non-ejecting pulse and the first and second droplet ejection pulse of the adjusted drive waveform form one or more of a positive pulse and a negative pulse with respect to a reference voltage, and wherein the waveform parameter comprises one or more of the areas of the non-ejecting pulse, the first droplet ejection pulse and the second droplet ejection pulse.

17. The method according to claim 16, wherein a net area is the resultant difference between the sum of the areas of all positive pulses and the sum of the areas of all negative pulses of the waveform, so that the non-ejecting pulse and the first and second droplet ejection pulses of the nominal drive waveform represent a nominal net area Anet(nominal), and wherein the non-ejecting pulse and the first and second droplet ejection pulses of the adjusted drive waveform represent an adjusted net area Anet(adjusted), and the waveform parameters are adjusted so that Anet(adjusted)<Anet(nominal).

18. A method for operating a droplet ejection apparatus, the droplet ejection apparatus comprising an actuator element of the droplet ejection apparatus, the actuator element bounding in part a pressure chamber, the pressure chamber being in fluidic communication with a nozzle, the actuator element arranged to deform so as to cause a droplet to be ejected from the nozzle: the method comprising providing an adjusted drive waveform to the actuator element, wherein the adjusted drive waveform comprises a droplet ejection pulse and a non-ejecting pulse arranged ahead of the droplet ejection pulse, wherein the first delay and/or the duration of the non-ejecting pulse is such that the non-ejecting pulse causes a priming pressure in the chamber below that which causes ejection of the droplet and the droplet ejection pulse causes the ejection of the droplet after the droplet ejection pulse further increases the priming pressure in the chamber to a droplet ejection pressure.

19. The method according to claim 18, wherein the droplet ejection pulse comprises a first and a second droplet ejection pulse, the second droplet ejection pulse being inverted from the first droplet ejection pulse, and the second droplet ejection pulse following the first droplet ejection pulse and causing the ejection of the droplet by further increasing the priming pressure in the chamber to a droplet ejection pressure.

20. (canceled)

21. The method according to claim 18, wherein the first delay is short compared to the duration of the non-ejecting pulse.

22. The method according to claim 18, wherein the non-ejecting pulse is inverted with respect to the droplet ejection pulse, or with respect to the second droplet ejection pulse.

23. The method according to claim 1, wherein the droplet ejection apparatus includes a fluid for ejection, wherein the fluid has a viscosity greater than 10 mPas.

24. (canceled)

25. (canceled)

26. A droplet ejection apparatus comprising a controller configured to carry out a method for providing a drive waveform for a droplet ejection apparatus, the method comprising the steps of:
receiving a nominal drive waveform comprising a droplet ejection pulse having a nominal maximum amplitude Vmax(nominal) and for achieving a nominal droplet velocity vel(nominal); and further comprising a non-ejecting pulse ahead of the droplet ejection pulse, wherein the non-ejecting pulse is spaced apart from the droplet ejection pulse by a first delay d1;
receiving a target droplet velocity vel(target) and/or a target maximum amplitude of the droplet ejection pulse Vmax(target);
adjusting one or more waveform parameters on the basis of the received target droplet velocity vel(target) and/or the target maximum amplitude of the droplet ejection pulse Vmax(target) to provide an adjusted drive waveform to achieve at least one of the target droplet velocity vel(target) and the target maximum amplitude of the droplet ejection pulse Vmax(target); and
outputting the adjusted drive waveform.
